(19) United States
(12) Patent Application Publication
(10) Pub. No.: US 2004/0064657 A1
(43) Pub. Date: Apr. 1, 2004

(54) Memory structure including information storage elements and associated validity storage elements

(76) Inventors: Muraleedhara Navada, Santa Clara, CA (US); Sreenath Kurupati, Santa Clara, CA (US)

Correspondence Address: BUCKLEY, MASCHOFF, TALWALKAR LLC, 5 ELM STREET, NEW CANAAN, CT, 06840, US

(21) Appl. No.: 10/256,301

(22) Filed: Sep. 27, 2002

(51) Int. Cl. G06F 12/00

(52) U.S. Cl. 711/156; 711/104

(57) ABSTRACT

According to some embodiments, a memory structure is provided including information storage elements and associated validity storage elements.

### BACKGROUND

In integrated circuits, information is stored and/or retrieved using memory structures. For example, a register that is comprised of resetable flip flop elements can be used to store and/or retrieve information (e.g., each flip flop element being able to represent “0” or “1”). One advantage associated with resetable flip flop elements is that each element automatically reverts to a default value when the integrated circuit is initialized (e.g., all of the flip flop elements might revert to “0” in response to a signal generated during a boot-up procedure). The flip flop elements, however, can occupy a significant amount of area, making it impractical to store a large amount of information in this way.

As another approach, a Random Access Memory (RAM) structure can be used to store and/or retrieve information. Although a RAM structure typically occupies less area as compared to resetable flip flop elements, the RAM structure will not automatically revert to default values when the integrated circuit is reset. As a result, the RAM structure must be initialized before being used to store and/or retrieve information. That is, information needs to be written into the entire RAM structure as part of a boot-up procedure (e.g., a “0” value may be written into each element of the RAM structure).

This initialization overhead can be costly in terms of the number of cycles and instructions required to prepare the RAM structure for use. Consider, for example, a network device. In this case, an Internet Packet (IP) address table may require a RAM structure capable of storing up to valid 40,000 entries (although the actual number of valid entries might be significantly less than 40,000). The initialization of the RAM structure will require that all 40,000 entries be initialized to “0”—including those entries that don't have valid information.

Moreover, when the RAM structure is separate from the processor (e.g., when the RAM structure is located off-chip), the processor may consume a number of cycles when accessing information—including, for example, information that is associated with entries that do not have valid information.

### BRIEF DESCRIPTION OF THE DRAWINGS

FIG. 1 is a block diagram of a memory structure according to some embodiments.

FIG. 2 is a flow chart of an initialization method according to some embodiments.

FIG. 3 is a flow chart of a method of storing information according to some embodiments.

FIG. 4 is a flow chart of a method of retrieving information according to some embodiments.

FIG. 5 illustrates an integrated circuit including a memory structure according to some embodiments.

### DETAILED DESCRIPTION

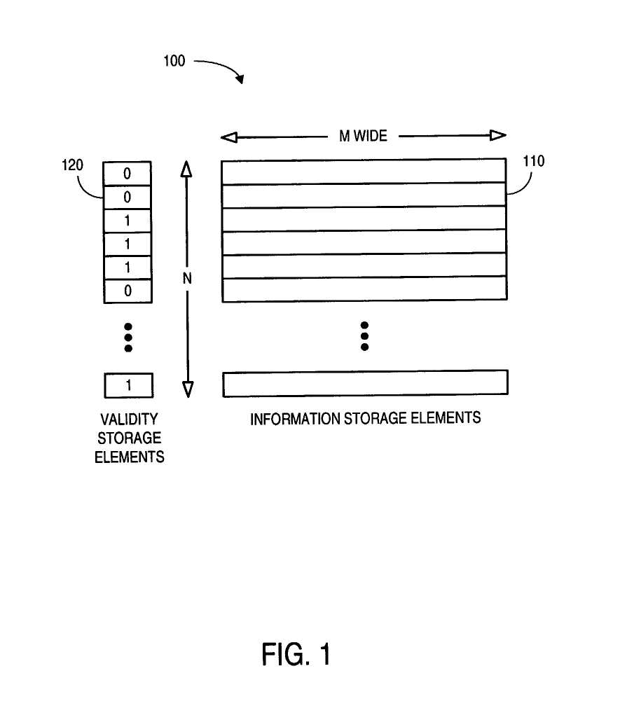

Referring now to the drawings, FIG. 1 is a block diagram of a memory structure 100 according to some embodiments. The memory structure 100 may be associated with, for example, a table in an integrated circuit, such as an Application Specific Integrated Circuit (ASIC) device.

The memory structure 100 includes a plurality of information storage elements 110. The information storage elements 110 may comprise, for example, “N” RAM storage elements (e.g., N rows) each capable of storing “M” bits of information (e.g., M bits wide).

Moreover, each information storage element 110 is associated with a validity storage element 120. According to some embodiments, the validity storage elements 120 are adapted to be reset to a first value (e.g., “0”). For example, the validity storage elements 120 may comprise N resetable flip flop elements (e.g., D, T, J-K, and/or R-S type resetable flip flop elements) that automatically revert to “0” when the integrated circuit is reset. Note that the validity storage elements 120 may be implemented using other devices, such as sequential logic devices, bi-stable gates, and/or any other appropriate type of logic device.

According to some embodiments, the validity storage elements 120 represent a N-bit validity vector for the memory structure 100. That is, each bit in the validity vector may have (i) a first value (e.g., “0”) indicating that the associated information storage element 110 does not contain valid information or (ii) a second value (e.g., “1”) indicating that the associated information storage element 110 does contain valid information.

The validity vector may then be used to determine if valid information is currently stored in a particular information storage element 110. For example, the appropriate validity storage element 120 may be checked before information is retrieved from the associated information storage element 110. If the validity storage element 120 contains a “0,” it may be determined that the associated information storage element 110 does not currently have valid information. If, on the other hand, the validity storage element contains a “1,” it may be determined that the associated information storage element 110 does have valid information (and the information can then be retrieved from that information storage element 110).

Because each validity storage element 120 automatically reverts to the first value (e.g., “0”) when the integrated circuit is reset, the memory structure 100 may be efficiently initialized. That is, during a boot-up procedure all of the bits in the validity vector 120 may automatically revert to the first value (e.g., indicating that all of the information storage elements 110 do not contain valid information). Information may then be stored in a subset of the information storage elements 110, and validity storage elements 120 associated with that subset may be changed to the second value (e.g., “1”) to indicate that those information storage elements 110 now contain valid information. Note that no action may be required with respect to the other information storage elements 110 (e.g., because the validity vector already indicates that those elements do not have valid information), reducing the overhead associated with the initialization of the memory structure 100.

Initialization Method

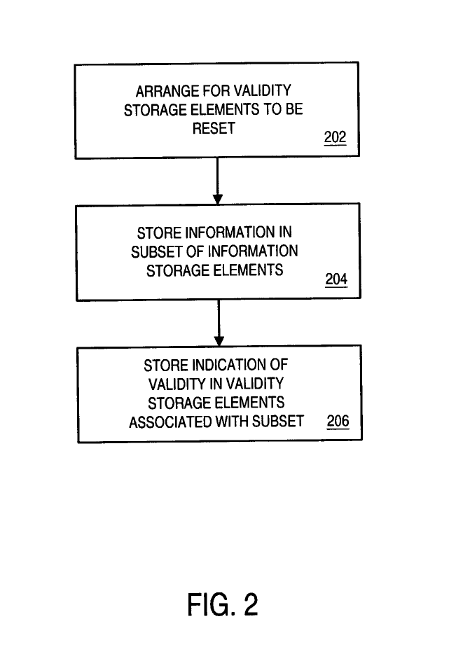

FIG. 2 is a flow chart of an initialization method according to some embodiments. The flow charts described herein do not imply a fixed order to the actions, and embodiments may be practiced in any order that is practicable. The method may be associated with, for example, the memory structure 100 described with respect to FIG. 1 during an initialization process (e.g., associated with an integrated circuit's boot-up procedure).

At 202, it is arranged for a plurality of validity storage elements 120 to be reset (e.g., to a first value during an initialization process). For example, a signal generated during a boot-up procedure may cause resetable flip flop elements in a validity vector to automatically revert to “0”. In other words, the reset may result in:

For (I=0; I<M; I++) val_vec[I]=0;

where val_vec[I] represents a validity storage element 120 (i.e., a resetable flip flop element in the validity vector).

At 204, information is stored in a subset of the information storage elements 110. For example, valid entries may be written into an IP address table stored in RAM. Moreover, at 206 an indication of validity is stored in the validity storage elements 120 associated with those information storage elements 110. For example, resetable flip flop elements associated with valid IP address entries in RAM may be set to “1”.

Information Storage Method

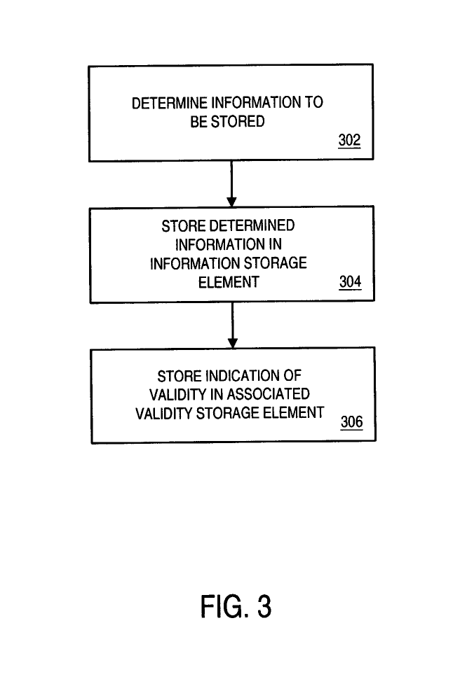

FIG. 3 is a flow chart of a method of storing information according to some embodiments. The method may be associated with, for example, the memory structure 100 described with respect to FIG. 1 during (or after) an initialization of the memory structure 100 (e.g., as described with respect to FIG. 2).

At 302, information to be stored is determined. For example, it may be determined that an IP address needs to be updated in an IP address table stored in RAM. At 304, the determined information is stored in an information storage element 110. For example, the information may be written into an IP address table.

At 306, an indication of validity is stored in the validity storage element 120 associated with that information storage element 110. For example, one or more resetable flip flop elements associated with the newly stored IP address may be set to “1”. In other words, writing “data” into information storage element “I” may comprise:

Mem[I]=data; val_vec[I]=1;

where mem[I] represents an information storage element 110 (e.g., in RAM) and val_vec[I] represents a validity storage element 120 (i.e., a flip flop element in the validity vector).

Information Retrieval Method

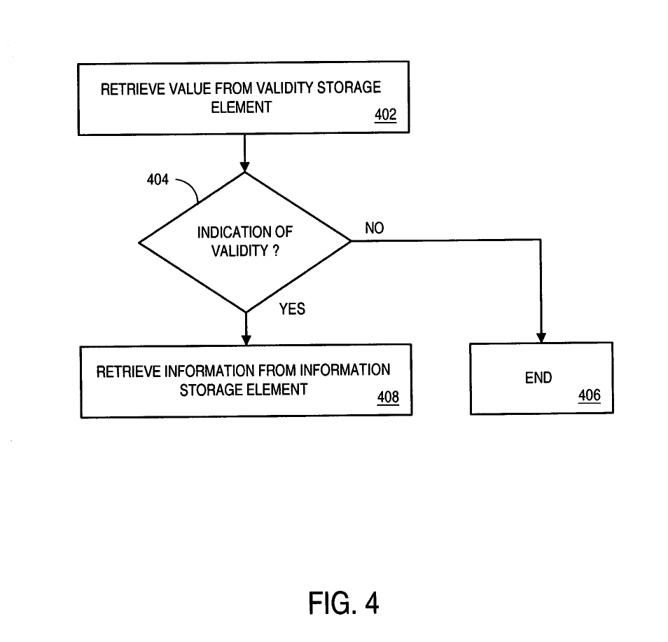

FIG. 4 is a flow chart of a method of retrieving information according to some embodiments. The method may be associated with, for example, the memory structure 100 described with respect to FIG. 1.

At 402, a value stored in a validity storage element 120 is retrieved. Consider, for example, the case when an IP address needs to be retrieved from the memory structure 100. In this case, the value of the appropriate bit (or bits) associated with the IP address (e.g., based on the location of the IP address in RAM) in the validity vector may be read.

If the value retrieved from the validity storage element 120 indicates that the associated information storage element 110 doesn't contain valid information at 404 (e.g., if the flip flop element indicates “0”), the process ends at 406. That is, the associated information storage element 110 does not contain valid information and thus no information can be (or needs to be) retrieved. According to some embodiments, a default value is substituted instead (e.g., a value of “0” might be substituted for whatever invalid information is actually contained in the information storage element 110).

If the value retrieved from the validity storage element 120 indicates that the associated information storage element 110 does contain valid information (e.g., if the flip flop element indicates “1”), the information is retrieved from the information storage element 110 at 408. In other words, retrieving “read data” from information storage element “I” may comprise:

If val_vec[I] read_data=mem[I];

Else read_data=0;

where mem[I] represents an information storage element 110 (e.g., in RAM) and val_vec[I] represents a validity storage element 120 (i.e., a resetable flip flop element in the validity vector).

Integrated Circuit

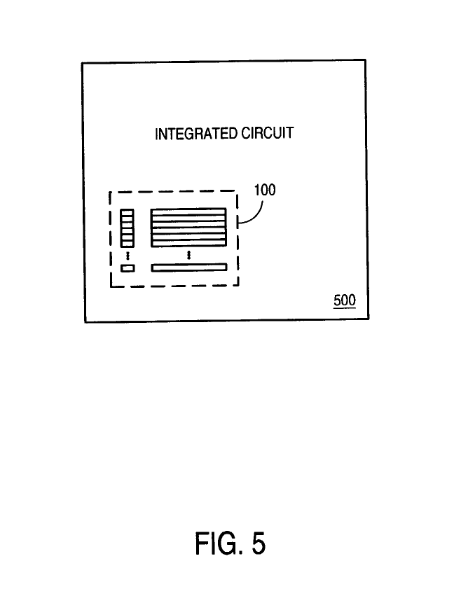

FIG. 5 illustrates an integrated circuit 500 including a memory structure 100 according to some embodiments. The memory structure 100 may comprise, for example: (i) N RAM storage elements, each RAM storage element being adapted to store M bits of information and (ii) a N-bit validity vector including a resetable flip-flop element associated with each RAM storage element, the resetable flip-flop elements being adapted to be reset to a pre-determined value (e.g., “0”) when the integrated circuit 500 is reset.

The integrated circuit 500 may be associated with, for example, a processor or a “network” device. As used herein, the term “network” may refer to, for example, a number of interconnected hardware devices and associated software through which information packets may be exchanged. For example, information packets may be exchanged in accordance with the Fast Ethernet Local Area Network (LAN) transmission standard 802.3-2002® published by the Institute of Electrical and Electronics Engineers (IEEE). Examples of network devices include network switches and routers.

Thus, embodiments of the present invention may use a RAM structure to store information, which will typically occupies less area in the integrated circuit 500 as compared to resetable flip flop elements. Moreover, resetable flip flop elements may be used to indicate whether or not information in the RAM structure is valid—reducing the initialization overhead (e.g., the number of cycles and instructions required) required to prepare the memory structure 100 for use. In addition, the number of cycles consumed accessing invalid information that is stored on a separate RAM structure may be reduced.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although embodiments described herein have provided a one-to-one relationship between information storage elements 110 and validity storage elements 120, other relationships could also be established. For example, a single validity storage element 120 might be associated with a number of different information storage elements 110 (e.g., with four rows in a RAM structure).

Moreover, although embodiments described herein have implemented the information storage elements 110 and validity storage elements 120 in a single integrated circuit 500, according to other embodiments these elements could instead be provided in separate integrated circuits.

Further, although software or hardware are described as performing certain functions, such functions may be performed using software, hardware, or a combination of software and hardware (e.g., a medium may store instructions adapted to be executed by a processor to perform a method of initializing, storing, and/or retrieving information).

The several embodiments described herein are solely for the purpose of illustration. Persons skilled in the art will recognize from this description other embodiments may be practiced with modifications and alterations limited only by the claims.

What is claimed is:

1. A memory structure, comprising:
a plurality of information storage elements; and
a validity storage element associated with each information storage element, the validity storage elements being adapted to be reset to a first value.

2. The memory structure of claim 1, wherein the information storage elements comprise random access memory.

3. The memory structure of claim 1, wherein the validity storage elements comprise a validity vector.

4. The memory structure of claim 3, wherein the plurality of information storage elements comprise N information storage elements, each information storage element being adapted to store M bits of information, and the validity vector comprises a N bit vector.

5. The memory structure of claim 4, wherein each bit in the validity vector may have: (i) the first value indicating that the associated information storage element does not contain valid information or (ii) a second value indicating that the associated information storage element contains valid information.

6. The memory structure of claim 5, wherein each bit in the validity vector is stored via a resetable flip-flop element.

7. The memory structure of claim 6, wherein the resetable flip-flop elements are adapted to be reset to the first value during a chip reset.

8. The memory structure of claim 1, wherein the memory structure is associated with at least one of: (i) a processor, (ii) a network device, (iii) a switch, and (iv) a router.

9. A method, comprising:
arranging for a plurality of validity storage elements to be reset to a first value during an initialization process, each validity storage element being associated with an information storage element;
storing information in a subset of the information storage elements; and
storing a second value in the validity storage elements associated with the subset of information storage elements.

10. The method of claim 9, wherein said arranging is associated with a chip reset.

11. A method, comprising:
determining information to be stored;
storing the determined information in an information storage element; and
storing a second value in a validity storage element associated with the information storage element, the validity storage element being adapted to be reset to a first value during an initialization process.

12. The method of claim 11, wherein the information storage element comprises random access memory and the validity storage elements comprise resetable flip-flop elements.

13. A method, comprising:
retrieving a value stored in a validity storage element, the validity storage element being adapted to be reset to a first value during an initialization process; and
if the retrieved value comprises a second value, retrieving information stored in an information storage element associated with the validity storage element.

14. The method of claim 13, wherein the information storage element comprises random access memory and the validity storage elements comprise resetable flip-flop elements.

15. A medium storing instructions adapted to be executed by a processor to perform a method, said method comprising:
arranging for a plurality of validity storage elements to be reset to a first value during an initialization process, each validity storage element being associated with an information storage element;
storing information in a subset of the information storage elements; and
storing a second value in the validity storage elements associated with the subset of information storage elements.

16. The medium of claim 15, wherein said arranging is associated with a chip reset.

17. A medium storing instructions adapted to be executed by a processor to perform a method, said method comprising:
determining information to be stored;
storing the determined information in an information storage element; and
storing a second value in a validity storage element associated with the information storage element, the validity storage element being adapted to be reset to a first value during an initialization process.

18. The medium of claim 17, wherein the information storage element comprises random access memory and the validity storage elements comprise resetable flip-flop elements.

19. A medium storing instructions adapted to be executed by a processor to perform a method, said method comprising:
retrieving a value stored in a validity storage element, the validity storage element being adapted to be reset to a first value during an initialization process; and
if the retrieved value comprises a second value, retrieving information stored in an information storage element associated with the validity storage element.

20. The medium of claim 19, wherein the information storage element comprises random access memory and the validity storage elements comprise resetable flip-flop elements.

21. A network device, comprising:
N random access memory storage elements, each random access memory storage element being adapted to store M bits of information; and
a N-bit validity vector including a resetable flip-flop element associated with each random access memory storage element, the resetable flip-flop elements being adapted to be reset to a pre-determined value during a chip reset.

22. The network device of claim 21, wherein the pre-determined value indicates that the associated random access memory storage element does not contain valid information.
